(19) United States
(12) Patent Application Publication
(10) Pub. No.: US 2024/0399409 A1
(43) Pub. Date: Dec. 5, 2024

(54) TREATMENT SYSTEM FOR TREATING WORKPIECES, AND TREATMENT METHOD

(71) Applicant: Dürr Systems AG, Bietigheim-Bissingen (DE)

(72) Inventors: Oliver IGLAUER-ANGRIK, Stuttgart (DE); Kevin WOLL, Heilbronn (DE); David DUPON, Bietigheim-Bissingen (DE); Dietmar WIELAND, Waiblingen (DE)

(21) Appl. No.: 18/557,474

(22) PCT Filed: Apr. 29, 2022
(86) PCT No.: PCT/DE2022/100324

§ 371 Date: Oct. 26, 2023

(30) Foreign Application Priority Data
Apr. 29, 2021 (DE) 10 2021 204 311.9

(51) Int. Cl. B05C 9/14; B05C 9/12; F26B 3/04; F26B 15/12; F26B 21/00

(52) U.S. Cl. CPC B05C 9/14; B05C 9/12; F26B 3/04; F26B 15/12; F26B 21/004; F26B 2210/12

(57) ABSTRACT

In order to provide a treatment system for treating workpieces—in particular, vehicle bodies—which system has a simple structure and enables energy-optimized and/or quality-optimized workpiece treatment, it is proposed that the treatment system comprise the following: a housing which surrounds a treatment chamber; a cooling gas flow supply for supplying a cooling gas flow to the treatment chamber; and a heating region which is adjacent to the cooling gas flow supply or forms a component thereof and which can preferably be heated to a temperature which is above a temperature of the cooling gas flow.

### RELATED APPLICATION

This application is a national Phase of international application No. PCT/DE2022/100324 filed on Apr. 29, 2022, and claims the benefit of German application No. 10 2021 204 311.9 filed on Apr. 29, 2021, which are incorporated herein by reference in their entirety and for all purposes.

### FIELD OF DISCLOSURE

Examples disclosed herein relate to a treatment system for treating workpieces. Such a treatment system is used in particular for treating vehicle bodies, wherein the vehicle bodies are in particular coated, e.g., painted, and/or subjected to drying and/or temperature control after the coating.

For example, such a treatment system can comprise one or more heating zones for heating the workpieces—in particular, the vehicle bodies—and one or more cooling zones for cooling the workpieces—in particular, the vehicle bodies.

### BACKGROUND

Particularly when a cooling zone follows a heating zone, condensate formation can occur in the cooling zone, which can lead to impairment of the treatment result of a workpiece to be treated. For example, condensate dripping from a ceiling wall of a treatment chamber can reach a coating of the workpiece and damage it.

### SUMMARY

The object of examples disclosed herein is to provide a treatment system for treating workpieces which is constructed simply and enables an energy-optimized and/or quality-optimized workpiece treatment.

According to examples disclosed herein, this object is achieved by a treatment system according to claim 1.

The treatment system for treating workpieces is used in particular to treat vehicle bodies, and preferably vehicle bodies of passenger cars.

The treatment system preferably comprises a housing which surrounds a treatment chamber.

The treatment system furthermore preferably comprises a cooling gas flow supply for supplying a cooling gas flow to the treatment chamber.

It is also preferably provided that the treatment system comprise a heating region which is adjacent to the cooling gas flow supply or forms a component thereof.

The heating region can preferably be heated to a temperature which is above a temperature of the cooling gas flow.

Preferably, the heating region can be heated in such a way that its temperature during the treatment of the workpieces can be permanently maintained above a temperature of the cooling gas flow.

The heating region is preferably maintained at a temperature of at least approximately 80° C., and preferably more than 100° C.

It may be favorable if the treatment system comprises a heating device for actively heating the heating region.

The heating device may in particular comprise an ohmic heater, a convective heater, and/or a radiant heater.

For example, it may be provided that a heating device which comprises or is an ohmic heater be integrated into or form a heating region to be heated. For example, a planar wall element may be or may comprise an ohmic heating element.

The heating region can preferably be actively heated by means of a heating device-for example, by means of heating gas. The heating gas is in particular a gas which is heated directly or indirectly by means of a burner device and/or by means of an ohmic heater, or is hot gas from another source.

Alternatively or additionally, it may be provided that the heating region be able to be heated passively—in particular, without a separate heating device. For example, it may be provided that the heating region be able to be heated by radiant heat from the workpieces arranged in the treatment chamber.

It may be advantageous if the heating region is or comprises a partition wall delimiting the treatment chamber.

The partition wall is formed, for example, from one or more metal sheets or comprises one or more metal sheets.

It may be provided that the partition wall come into direct contact or be in direct contact with an atmosphere in the treatment chamber.

An inner side of the partition wall is preferably arranged to face the treatment chamber.

An outer side of the partition wall is preferably arranged to face away from the treatment chamber.

The partition wall may, for example, have several portions—in particular, flat portions—which are in particular arranged at different angles to one another.

For example, the partition wall may have several, e.g., two or three, portions, wherein two portions are in each case adjacent to one another at a flat angle of, for example, at least approximately 110° and/or at most approximately 160°.

The partition wall is preferably formed to be at least approximately adapted to a portion of an outer contour of the workpieces to be treated.

For example, in the case of workpieces formed as vehicle bodies, the partition wall comprises a portion which extends at least approximately parallel to a windshield region of the vehicle bodies, and a further portion which extends at least approximately parallel to a front hood region of the vehicle bodies.

In particular, the partition wall separates off a corner region of a substantially cuboidal interior of the housing, wherein the remaining part of the interior forms the treatment chamber.

The part of the interior of the housing that is separated off by means of the partition wall in particular comprises a heating gas chamber and/or a cooling gas chamber.

An outer side, facing away from the treatment chamber, of the partition wall preferably delimits a heating gas chamber to which heating gas can be supplied from a heating gas flow supply of the treatment system.

It may be provided that an outer side, facing away from the treatment chamber, of the partition wall be provided with a thermal insulation. In particular, passive heating of the partition wall due to thermal radiation of the workpieces can thereby be optimized.

On the other hand, the partition wall is preferably not provided with a thermal insulation on the outer side facing away from the treatment chamber, so that heating gas supplied in particular on this outer side can deliver heat to the partition wall and thereby heat it.

The cooling gas flow supply is preferably guided through the heating region and/or surrounded by the heating region.

Preferably, the cooling gas flow supply is directly adjacent to and/or opens into the treatment chamber.

In particular, it may be provided that the cooling gas flow supply comprise one or more cooling gas flow channels which end at openings in the partition wall and thus enable cooling gas to be guided through the partition wall.

It may be advantageous if the cooling gas flow supply comprises one or more cooling gas flow channels for introducing the cooling gas flow into the treatment chamber, wherein one or more of the cooling gas flow channels preferably traverse a heating gas chamber for heating the heating region.

Heating gas for heating the heating region preferably flows or can flow around the cooling gas flow channels.

One or more of the cooling gas flow channels preferably fluidically connect a cooling gas chamber to the treatment chamber.

The cooling gas chamber is in particular a part of the interior of the housing that is arranged on a side, facing away from the treatment chamber, of the heating gas chamber.

The heating gas chamber is preferably arranged between the cooling gas chamber and the treatment chamber.

A fluidic connection of the cooling gas chamber to the treatment chamber is to be understood in particular to mean that cooling gas supplied to the cooling gas chamber, e.g., via a supply channel and/or a pressure chamber, can be introduced into the treatment chamber via the cooling gas flow channels.

One or more intermediate walls are preferably arranged between the heating gas chamber and the cooling gas chamber.

The one or more intermediate walls are formed, for example, from one or more metal sheets or each comprise one or more metal sheets.

In one configuration of examples disclosed herein, a thermal insulation, e.g., insulation material or insulating material, can be arranged on one or between two intermediate walls—in particular, in order to avoid or at least reduce a heat transfer from the heating gas chamber to the cooling gas chamber.

It may also be advantageous if the one or more cooling gas flow channels are provided with a thermally-insulating casing. As a result, a heat transfer from the heating gas located in the heating gas chamber to the cooling gas conducted in the cooling gas flow channels can preferably be avoided or at least minimized.

The heating gas chamber for heating the heating region is preferably fluidically connected to the treatment chamber.

In particular, it may be provided that the treatment system comprise one or more connection slots for fluidically connecting the heating gas chamber to the treatment chamber.

The heating gas used for heating the heating region-in particular, the partition wall—can then preferably be completely supplied to the treatment chamber. A separate heating gas discharge can preferably be dispensable as a result.

It may be favorable if the one or more connection slots are arranged between a portion of a treatment chamber wall—in particular, of a partition wall—of the treatment system, which portion forms a heating region, and a further portion of a treatment chamber wall of the treatment system, behind which portion in particular no heating gas flows.

The treatment chamber wall is preferably formed largely by four housing walls of the housing, wherein a portion of the treatment chamber wall is formed by the partition wall which separates off a part of the interior of the housing.

In particular, one or more connection slots are preferably arranged and/or formed on one or more transition regions between the partition wall and one or more housing walls of the housing.

One or more connection slots are preferably formed as a gap between the partition wall or another portion of a treatment chamber wall of the treatment system, which portion forms a heating region on the one hand, and a further portion of a treatment chamber wall on the other.

In particular, it may be provided that one or more of the connection slots be arranged between a) a portion of the treatment chamber wall, which portion forms an at least approximately vertical side wall, and b) a heating region.

Alternatively or additionally, it may be provided that one or more of the connection slots be arranged between a) a portion of the treatment chamber wall, which portion forms an at least approximately horizontal ceiling wall, and b) a heating region.

In particular, it may be provided that the treatment system comprise a single heating region, which is adjacent to housing walls on both sides, wherein an arrangement of the heating region, which arrangement is spaced apart from the housing wall and/or forms a gap with the housing wall, is preferably provided in one or both transition regions to the housing walls-in particular, towards a side wall and/or towards a ceiling wall.

One or more connection slots are formed, for example, by means of spacers, and in particular washers, for arranging the partition wall to be evenly spaced from a housing wall.

It may be provided that the heating gas flow supply form or comprise a flow guide by means of which lock supply air from a lock of the treatment system or from the supply channel can be supplied as heating gas to the heating region for heating the heating region. The supplied heating gas is solvent-free fresh air so that condensate formation within the heating region is not possible.

In this description and the appended claims, a flow guide is in particular formed from one or more channels for gas guidance, one or more conditioning devices for cooling, heating, humidifying, and/or dehumidifying gas, and/or one or more fans for driving a gas flow. The components of the flow guide are formed, arranged, and/or set up such that the functionally-described gas guidance is made possible.

The heating region serves in particular to heat portions of the treatment chamber wall—in particular, regions of the treatment system that come into contact with the atmosphere of the treatment chamber-at least partially to a temperature which makes condensate formation impossible on the side facing the treatment chamber. For example, heating of the heating region to above a boiling temperature of the medium potentially accumulating as condensate—in particular, solvent and/or water—takes place.

In particular, a portion of the treatment chamber wall, through which portion cooling gas for cooling the workpieces is guided and which portion is consequently itself potentially cooled down in such a way that condensate can accumulate, is provided as a heating region.

By means of the heating region, condensate accumulation can preferably be completely avoided.

As an alternative or in addition to such a heating region, a suitable configuration of the cooling gas flow channels and/or of nozzles for supplying cooling gas to the treatment chamber may be advantageous.

For example, a cooling gas flow supply may be provided in or on the partition wall and/or an in particular vertical side wall of the housing, which cooling gas flow supply comprises nozzles which, starting from the partition wall and/or side wall, project into the treatment chamber.

Condensate forming in the region of the side wall can then flow off in particular around the inward-projecting nozzles and thus cannot drip above the supplied cooling gas flow and be entrained by the latter.

Furthermore, alternatively or additionally, heating of treatment chamber walls—in particular, of an at least approximately horizontal ceiling wall and/or of a vertical side wall—may be provided.

The heating of these treatment chamber walls takes place, in particular, by supplying heating gas from the heating gas chamber, and in particular through connection slots which connect an interior of the treatment chamber wall to the heating gas chamber.

At an end, facing away from the heating gas chamber, of the respective interior of the respective treatment chamber wall, the heating gas supplied for heating the heating chamber wall can preferably be discharged—in particular, into a discharge device outside the housing—or can be introduced into the treatment chamber.

The heating gas is in particular fresh air heated via a fresh air heat exchanger.

In particular, the heating gas can be heated fresh air after the latter has been supplied to a lock of the treatment system. Alternatively, it may be provided that a part of the heated fresh air to be supplied to the lock branch off and be used directly as heating gas for heating the heating region.

The cooling gas flow supply preferably comprises one or more flaps and/or one or more valves and/or one or more flow regulators—in particular, one or more controllable frequency converters on one or more fans-and/or one or more sensors-in particular, in order to be able to control a mass flow and/or volume flow of the cooling gas flow.

The heating gas flow supply preferably comprises one or more flaps and/or one or more valves and/or one or more flow regulators and/or sensors—in particular, in order to be able to control a mass flow and/or volume flow of the heating gas flow.

By controlling the volume flow and/or mass flow of the heating gas flow, a temperature of the heating region can in particular be controlled.

In particular, it may be provided that, by means of the heating gas flow supply, a temperature of the heating region be maintained at at least the evaporation temperature of the medium potentially accumulating as condensate—preferably at least approximately 5 K above, e.g., at least approximately 10 K above, and/or at most approximately 50 K above, and preferably at most approximately 30 K, the same.

The supply of the heating gas to the heating gas chamber can in particular take place through a perforation from a lock box of an adjacent lock.

Preferably, all cooling gas flow channels are sealed by welding in order to prevent cooling gas from flowing out into the heating gas chamber and/or to avoid heating gas penetrating into regions filled with cooling gas.

The heating gas is preferably supplied by means of the heating gas flow supply under increased pressure in such a way that a higher pressure prevails in the heating gas chamber than in the treatment chamber—in particular, a pressure increased by at least 10 mbar, e.g., at least approximately 50 mbar, and preferably at least 100 mbar.

Preferably, a volume flow of the supplied heating gas flow is at least approximately 50 Nm³/h, and in particular at least approximately 150 Nm³/h, and/or at most approximately 1,000 Nm³/h, and preferably at most approximately 500 Nm³/h.

One or more connection slots are preferably arranged in edge regions in order to ensure a temperature increase in particular at the regions that are critical for condensate formation due to the geometry.

As an alternative to a supply of the heating gas flow to the treatment chamber, recirculation or another use of the heating gas flow may be provided. For example, the heating gas flow may be used as the supply air flow for a lock of the treatment system.

Furthermore, a combination may be provided in such a way that part of the supplied heating gas flow is introduced into the treatment chamber, and a further part is otherwise discharged and/or utilized further.

Preferably, different slot widths are provided at different connection slots. As a result, the quantity—in particular, the volume flow and/or mass flow—of the heating gas exiting through the respective connection slot can be varied. The slot widths can be adjusted, for example, by suitably selecting the number and thickness of distance pieces, e.g., washers.

It may be advantageous if a housing wall and/or treatment chamber wall formed as a ceiling wall is oriented only approximately horizontally and encloses an angle with the horizontal of, for example, at least 2°, and preferably at least 5°. As a result, in the undesired case of condensate formation, it can be ensured that condensate drops flow off towards a side wall of the housing, in order to, in particular, avoid condensate dripping onto the workpieces to be treated.

Examples disclosed herein further relate to a treatment method for treating workpieces—in particular, vehicle bodies.

In this respect, examples disclosed herein are based upon the object of providing a method which is simple to implement and enables energy-optimized and/or quality-optimized workpiece treatment.

According to examples disclosed herein, this object is achieved by the independent method claim.

The method for treating workpieces in particular comprises the following:
introducing one or more workpieces into a treatment chamber surrounded by a housing, and/or conveying one or more workpieces through the treatment chamber;
supplying a cooling gas flow by means of a cooling gas flow supply to the treatment chamber for cooling the one or more workpieces;
heating a heating region adjacent to the cooling gas flow supply-preferably to a temperature which is above a temperature of the supplied cooling gas flow.

The method according to examples disclosed herein is suitable in particular for being carried out in a treatment system according to examples disclosed herein or by using a treatment system according to examples disclosed herein.

The treatment system according to examples disclosed herein is in particular suitable for carrying out the method according to examples disclosed herein.

The method preferably has one or more of the features and/or advantages described in connection with the treatment system according to examples disclosed herein.

Furthermore, the treatment system according to examples disclosed herein preferably has one or more of the features and/or advantages described in connection with the method.

Further preferred features of examples disclosed herein are the subject matter of the following description and the representation of exemplary embodiments in the drawings.

### BRIEF DESCRIPTION OF THE DRAWINGS

FIG. 1 a schematic, partially sectional representation of a cooling module of a treatment system for treating workpieces;

FIG. 2 a schematic vertical section through the treatment system of FIG. 1;

FIG. 3 an enlarged representation of region III in FIG. 2;

FIG. 4 an enlarged representation of region IV in FIG. 2;

FIG. 5 a schematic, partially sectional representation of a heating region of the treatment system of FIG. 1, wherein inspection accesses are additionally shown;

FIG. 6 a vertical sectional representation of a nozzle box of the treatment system of FIG. 1, wherein insulation is provided between a heating gas chamber and a cooling gas chamber;

FIG. 7 a schematic perspectival representation of an alternative embodiment of a cooling gas chamber;

FIG. 8 a schematic, vertical sectional representation of the alternative cooling gas chamber of FIG. 7 together with surrounding components of the treatment system corresponding to the treatment system according to FIG. 1;

FIG. 9 a schematic vertical section through a third embodiment of the treatment system, in which a heated side wall is provided;

FIG. 10 a schematic vertical section through a fourth embodiment of the treatment system, in which a heated ceiling wall is provided;

FIG. 11 a schematic representation of a section of a vertical side wall of a fifth embodiment of a treatment system, in which nozzles projecting into the treatment chamber are provided;

FIG. 12 a schematic, perspectival rear view of the side wall and the nozzles, arranged therein, of FIG. 11; and

FIG. 13 a schematic, optional development of the inward-projecting nozzles.

The same or functionally equivalent elements are provided with the same reference signs in all figures.

### DETAILED DESCRIPTION OF THE DRAWINGS

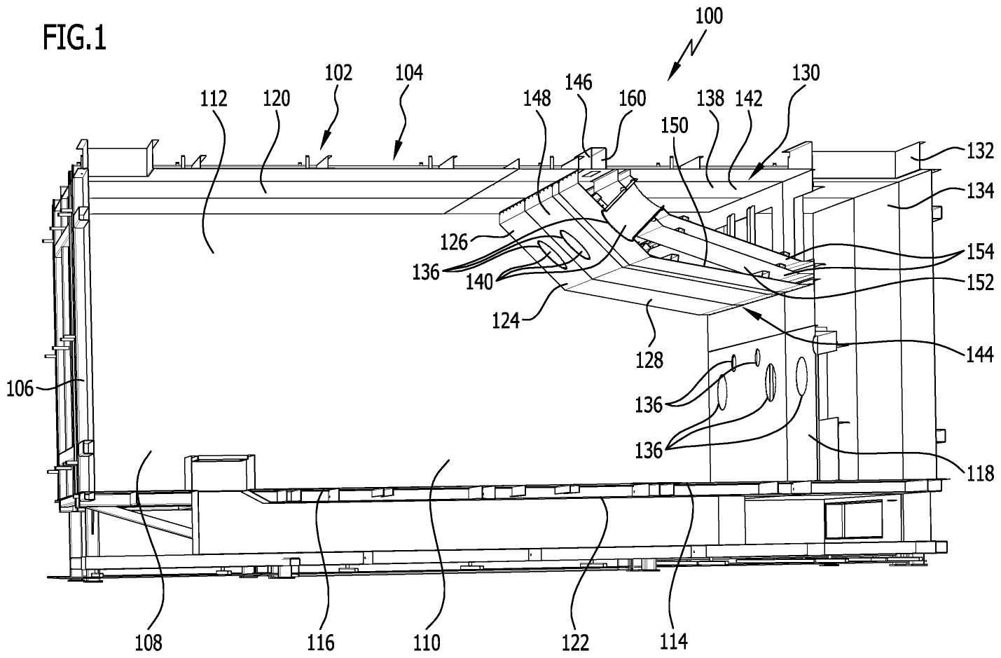

A treatment system shown in FIGS. 1 through 4 and denoted as a whole by 100 is used to treat workpieces (not shown). The treatment system 100 is in particular a dryer 102 of a paint shop for painting vehicle bodies.

The treatment system 100 in particular comprises one or more heating modules (not shown) and one or more cooling modules 104 (see FIG. 1) adjoining the heating modules.

The cooling module 104 comprises a substantially cuboidal housing 106 which delimits a cuboidal interior 108.

A treatment chamber 110 is arranged in the interior 108.

The housing 106 thus also surrounds the treatment chamber 110.

The treatment chamber 110 is in particular part of the interior 108 of the housing 106.

The workpieces can be introduced into or guided through the treatment chamber 110 by means of a conveying device (not shown).

In the process, the temperature of the workpieces can in particular be controlled; for example, they can be cooled in the cooling module 104.

The cooling module 104 is in particular a component of a cooling zone 112 of the treatment system 100, or forms a cooling zone 112.

The treatment chamber 110 is surrounded by several treatment chamber walls 114.

A treatment chamber wall 114 is in particular a base wall 116. In addition, two, at least approximately vertical, side walls 118 and a ceiling wall 120 of the housing 106 are treatment chamber walls 114.

The treatment chamber walls 114 mentioned are thus in particular also housing walls 122 of the housing 106.

The interior 108 of the housing 106 is divided by means of a partition wall 124 into the treatment chamber 110 and further chambers to be described within the interior 108.

The partition wall 124 thus likewise forms a treatment chamber wall 114 which delimits the treatment chamber 110.

The partition wall 124 is in particular formed from one or more metal sheets 126 or comprises one or more metal sheets 126.

During operation of the treatment system 100, an inner side 128 of the partition wall comes into contact with gas located in the treatment chamber 110.

The treatment system 100 furthermore comprises a cooling gas flow supply 130 for supplying a cooling gas flow to the treatment chamber 110.

The cooling gas flow supply 130 in this case comprises a supply channel 132 to which cooled or cold gas, and in particular cooled or cold air, can be supplied.

The cooling gas flow supply 130 furthermore comprises a pressure chamber 134 for distributing the cooling gas flow to several supply openings 136 for supplying the cooling gas flow to the treatment chamber 110.

Furthermore, the cooling gas flow supply 130 comprises a cooling gas chamber 138, which is in particular a component of the interior 108 of the housing 106 and serves to distribute the cooling gas flow onto several cooling gas flow channels 140 of the cooling gas flow supply 130.

The cooling gas chamber 138 is in particular a cooling gas box 142.

A nozzle box 144 of the treatment system 100 for supplying the cooling gas flow to the treatment chamber 110 is in particular formed by means of the cooling gas chamber 138 and the cooling gas flow channels 140, and by means of the partition wall 124.

When cooling gas is supplied to the treatment chamber 110, local cooling of regions of the housing 106 can occur. If, for example, gas which has slightly condensing components reaches the treatment chamber 110 through a lock or by another admixture of gas, condensate formation can occur in the housing 106, and in particular on the treatment chamber walls 114.

In particular, air moisture can condense on cold regions of the treatment chamber walls 114 and reach the workpieces to be treated. As a result, the quality of the workpieces could be impaired.

The treatment system 100 therefore preferably comprises a heating gas flow supply 146 in addition to the cooling gas flow supply 130.

A heating region 148 of the treatment system 100 can be heated by means of the heating gas flow supply 146.

The heating region 148 is or comprises in particular the partition wall 124.

The heating region 148 preferably surrounds the cooling gas flow channels 140 of the cooling gas flow supply 130 in the region of the transition into the treatment chamber 110.

By means of the heating gas flow supply 146, heating gas can in particular flow behind the partition wall 124 in order to transfer heat to the partition wall 124 and thus to heat the partition wall 124.

For this purpose, an outer side 150, facing away from the treatment chamber 110, of the partition wall 124 comes into contact—in particular, directly—with the heating gas supplied via the heating gas flow supply 146.

A heating gas chamber 152 is arranged and/or formed on the side, facing away from the treatment chamber 110, of the partition wall 124.

The heating gas chamber 152 is arranged in particular between the cooling gas chamber 138 and the treatment chamber 110 and is separated, on the one hand, from the treatment chamber 110 by means of the partition wall 124 and, on the other, from the cooling gas chamber 138 by means of one or two intermediate walls 154.

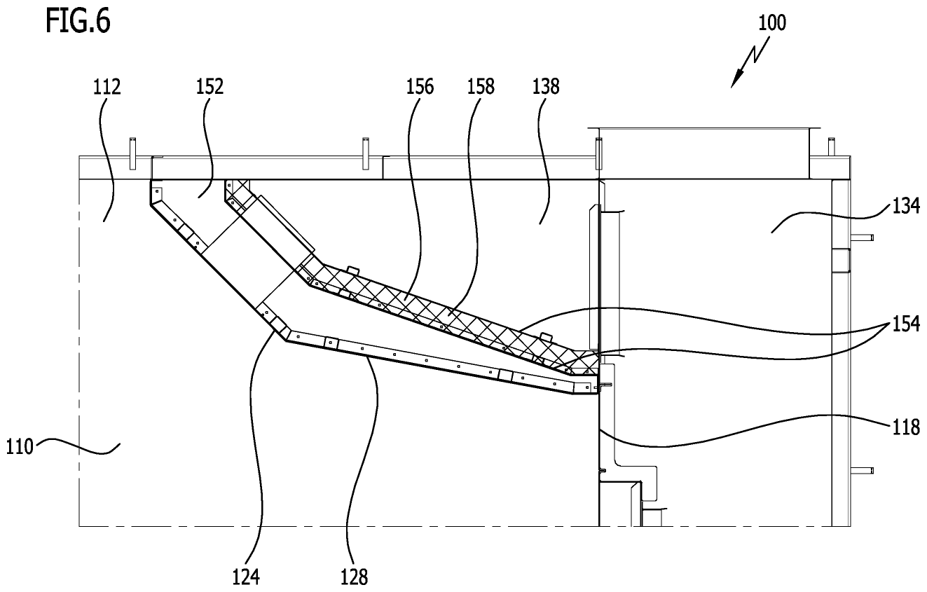

The one or more intermediate walls 154 serve in particular for the thermal insulation of the heating gas chamber 152 from the cooling gas chamber 138. As can be seen in particular in FIG. 6, it may optionally be provided that a region between two intermediate walls 154 or one of the intermediate walls 154 be provided with an insulating material 156 or insulation material 158 in order to optimize the insulation effect.

The heating gas flow can preferably be introduced into the heating gas chamber 152 via a supply channel 160 of the heating gas flow supply 146.

The heating gas can, for example, be discharged from the heating gas chamber 152 via a heating gas flow discharge (not shown). As a result, an admixture of heating gas to the gas located in the treatment chamber 110 can in particular be avoided in order not to impair the cooling of the workpieces.

Preferably, however, no such separate heating gas flow discharge is provided. Rather, the heating gas is preferably supplied in small quantities, in comparison to the cooling gas flow, so that an admixture of the heating gas to the gas located in the treatment chamber 110 does not result in any temperature impairment worth mentioning.

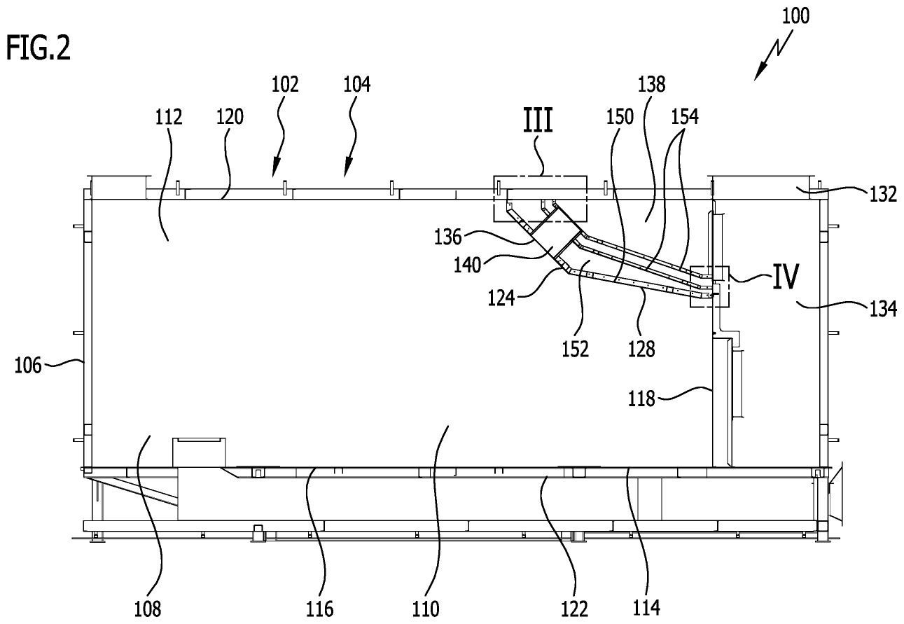

In order to supply the heating gas from the heating gas chamber 152 to the treatment chamber 110, one or more connection slots 162 are preferably provided (see in particular FIGS. 2 through 4).

The one or more connection slots 162 are in particular formed as a gap 164 between the partition wall 124 and an adjacent part of the housing wall 122.

A gap thickness of the gap 164 can preferably be adjusted by means of weld studs 166, L-angles 168, and washers (not shown) or other spacers. In particular, a constant gap width can preferably be adjusted over the entire length of the gap 164.

By suitably selecting the gap widths at different points between the partition wall 124 and the housing wall 122, it is also possible to vary a distribution of the delivered heating gas flow onto different regions within the treatment chamber 110. Thus, the heat distribution within the heating gas chamber can also be adjusted so that the partition wall is preferably flowed behind in the upper or lower region and is thus heated.

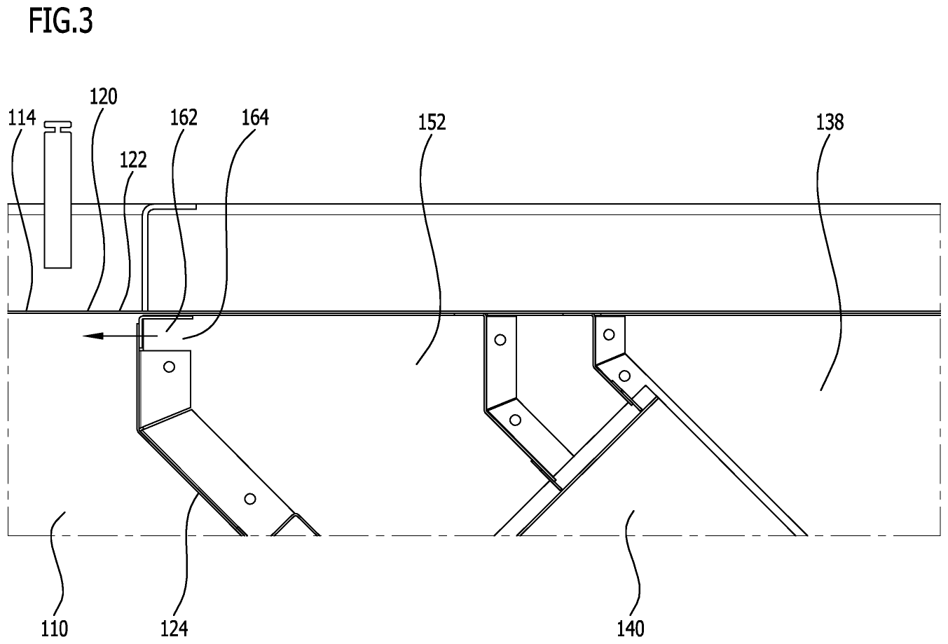

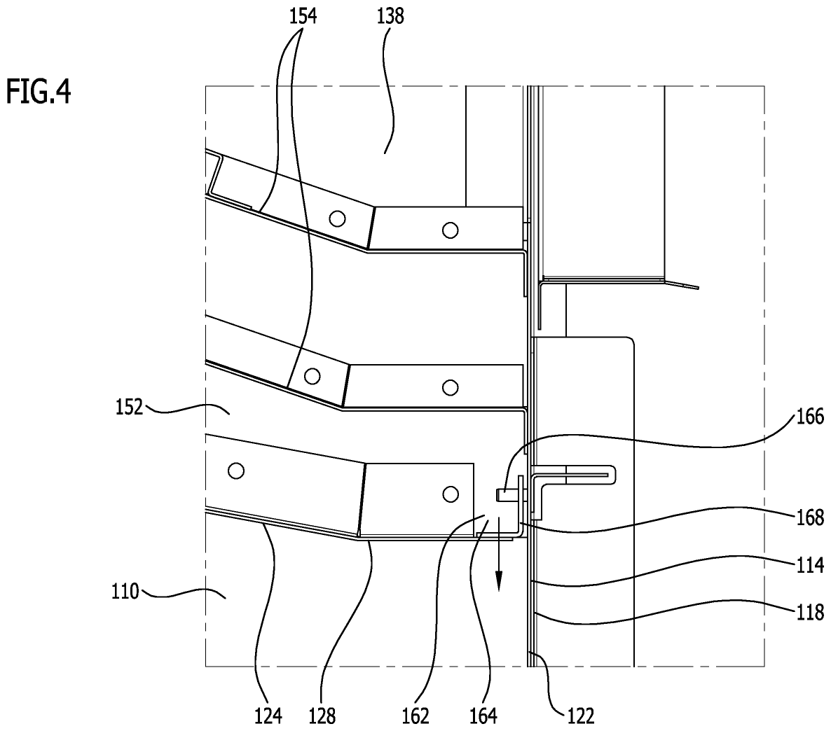

As can be seen in particular in FIGS. 3 and 4, a gap 164 is arranged, e.g., in the ceiling region, i.e., in the region of a transition between the partition wall 124 and the ceiling wall 120.

As a result, the ceiling wall 120 is subjected to heating gas starting from the heating gas chamber 152 and is thereby heated. This can also reduce or entirely avoid condensate formation in the region of the part, adjacent to the partition wall 124, of the ceiling wall 120.

Likewise, according to FIG. 4, heating gas can exit at the transition region between the partition wall 124 and the vertical side wall 118 and thereby heat the vertical side wall 118 at least in the region adjacent to the partition wall 124.

The nozzle box 144, arranged in an upper corner region of the interior 108 of the housing 106, for supplying the cooling gas flow can preferably be heated by the described heating gas flow supply 146 in such a way that no condensate is produced. A workpiece guided through directly below the nozzle box 144 at least in portions is thereby effectively protected from dripping impurities.

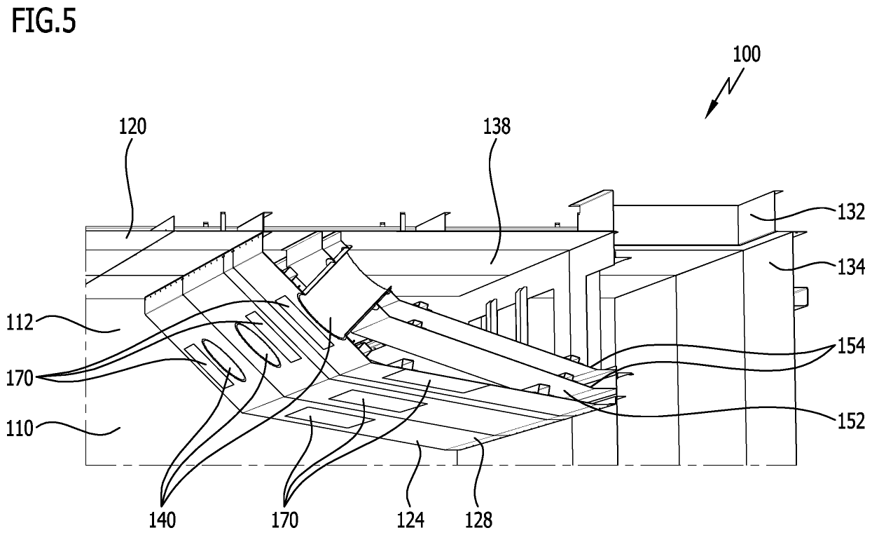

As can be seen in particular in FIG. 5, one or more inspection accesses 170 can optionally be arranged in the partition wall 124. As a result, the heating gas chamber 152 is accessible in particular from the treatment chamber 110 in order to be able to carry out maintenance work and/or cleaning work.

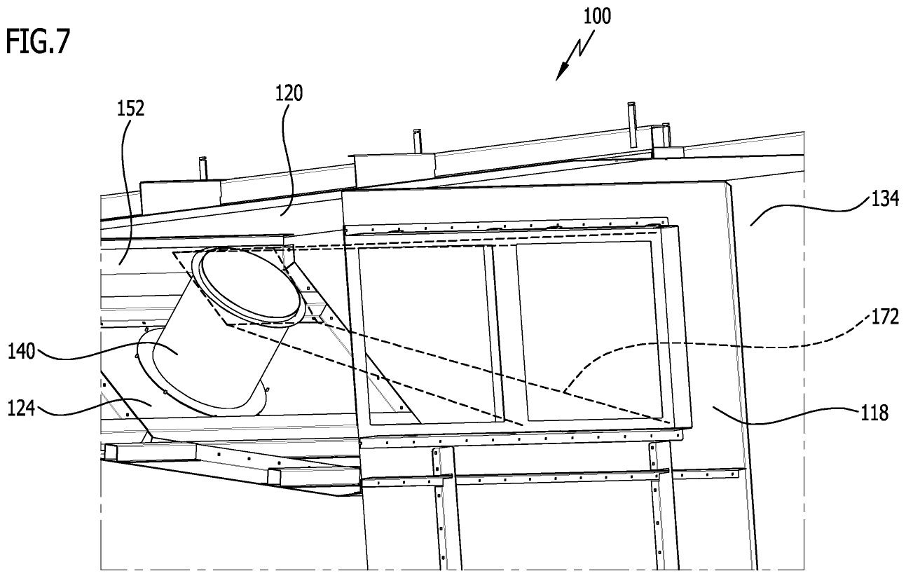

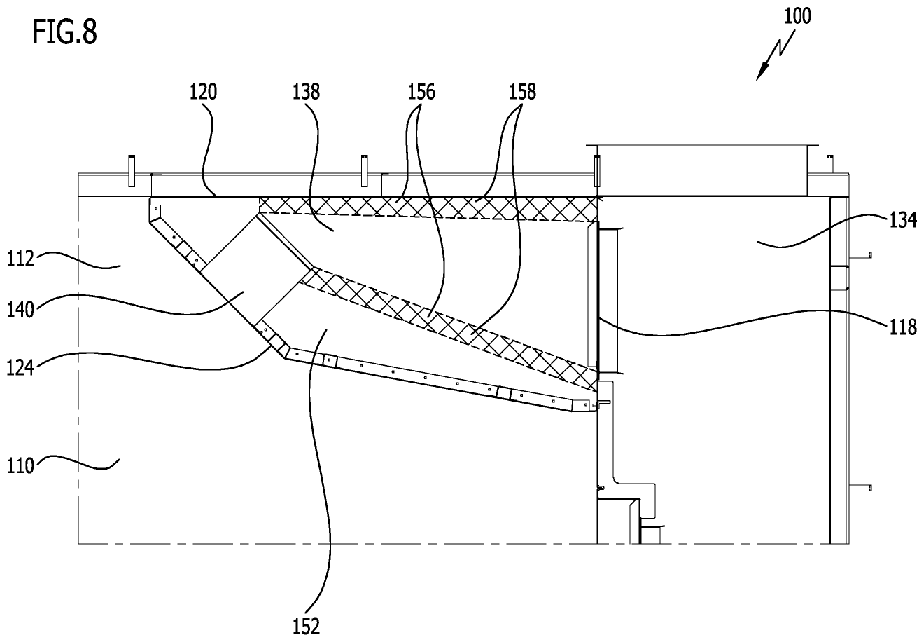

A second embodiment of the treatment system 100 shown in FIGS. 7 and 8 differs from the embodiment shown in FIGS. 1 through 4 essentially in that no cooling gas chamber 138 common to several cooling gas flow channels 140 is provided within the interior 108 of the housing 106.

In particular, no cooling gas box 142 is provided in the part, separated off by means of the partition wall 124, of the interior 108 of the housing 106.

Rather, separate guide channels 172 are provided for each cooling gas flow 140 and extend from a vertical side wall 118 of the housing 106 up to the cooling gas flow channels 140 and/or supply openings 136 in the partition wall 124.

By means of the guide channels 172, which could also form the cooling gas flow channels 140, cooling gas can thus be guided through the heating gas chamber 152.

As can be seen in particular in FIG. 8, the guide channel 172 or also, optionally, the cooling gas flow channel 140 are provided with thermal insulation, and in particular insulating material 156 or insulation material 158.

Otherwise, the embodiment of the treatment system 100 shown in FIGS. 7 and 8 corresponds, in terms of structure and function, to the embodiment shown in FIGS. 1 through 4, such that reference is made in this respect to the above description thereof.

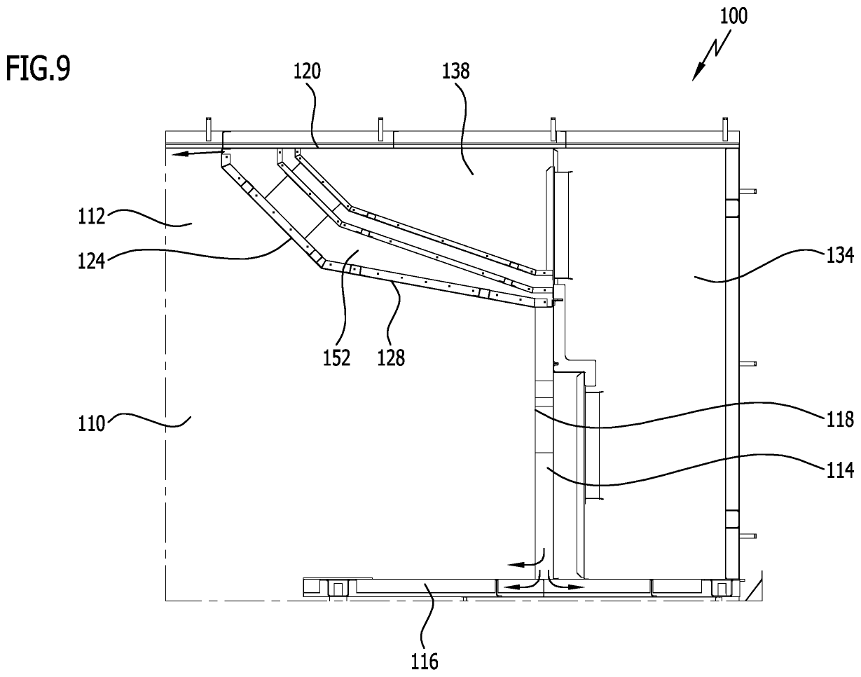

A third embodiment of the treatment system 100 shown in FIG. 9 differs from the first embodiment shown in FIGS. 1 through 4 essentially in that the treatment chamber wall 114, which forms a vertical side wall 118, is adjacent to the connection slot 162 in the transition between the partition wall 124 and the side wall 118 and is arranged in such a way that heating gas flowing out of the connection slot 162 does not flow directly into the treatment chamber 110, but, rather, flows through the latter within the treatment chamber wall 114 and thus heats the treatment chamber wall 114.

As is indicated by the arrows in FIG. 9 in the region of the transition from the side wall 118 into the base wall 116, the heating gas can optionally be introduced into the treatment chamber 110 at a lower end of the treatment chamber wall 114 (the upper left arrow of the three arrows in FIG. 9), or else can be discharged in some other way (the right arrow of the three arrows in FIG. 9). Alternatively or additionally, conducting the heating gas further into a base region—in particular, into the base wall 116—may be provided in order to also achieve a local increase in temperature there, and to thus avoid condensate formation (the lower left arrow of the three arrows in FIG. 9).

By heating the side wall 118 by means of the heating gas, condensate formation can also be effectively avoided in the region of the side wall 118.

Otherwise, the third embodiment shown in FIG. 9 corresponds, in terms of structure and function, to the embodiment shown in FIGS. 1 through 4, such that reference is made in this respect to the above description thereof.

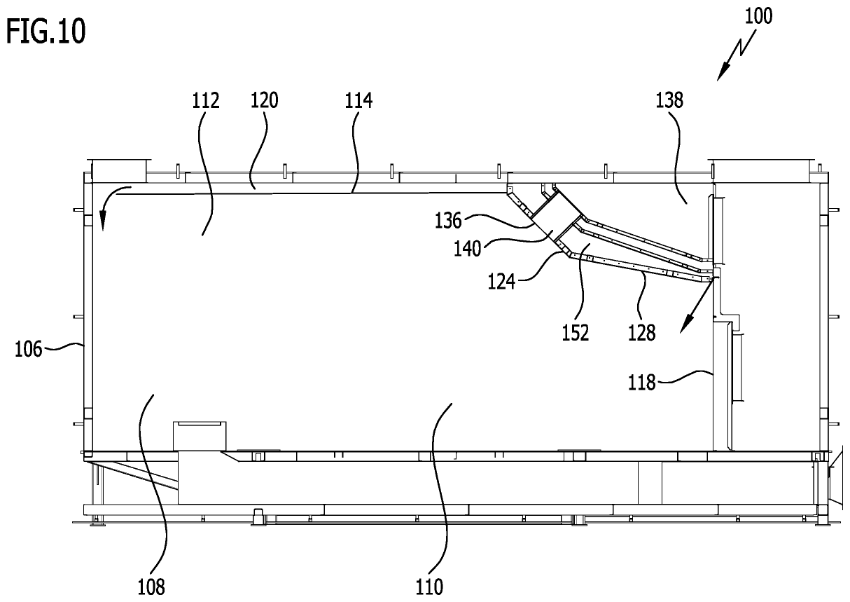

A fourth embodiment of a treatment system 100 shown in FIG. 10 differs from the third embodiment shown in FIG. 9 essentially in that the heated treatment chamber wall 114 forms the ceiling wall 120, which can thus be flowed behind.

The ceiling wall 120 can thus be heated by means of the heating gas from the heating gas chamber 152 in order to avoid condensate formation in the ceiling region.

The heating gas introduced into the treatment chamber wall 114 in particular exits into the treatment chamber 110 at an end region, facing away from the partition wall 124, of the ceiling wall 120.

Otherwise, the fourth embodiment of the treatment system 100 shown in FIG. 10 corresponds, in terms of structure and function, to the third embodiment shown in FIG. 9, such that reference is made in this respect to the above description thereof.

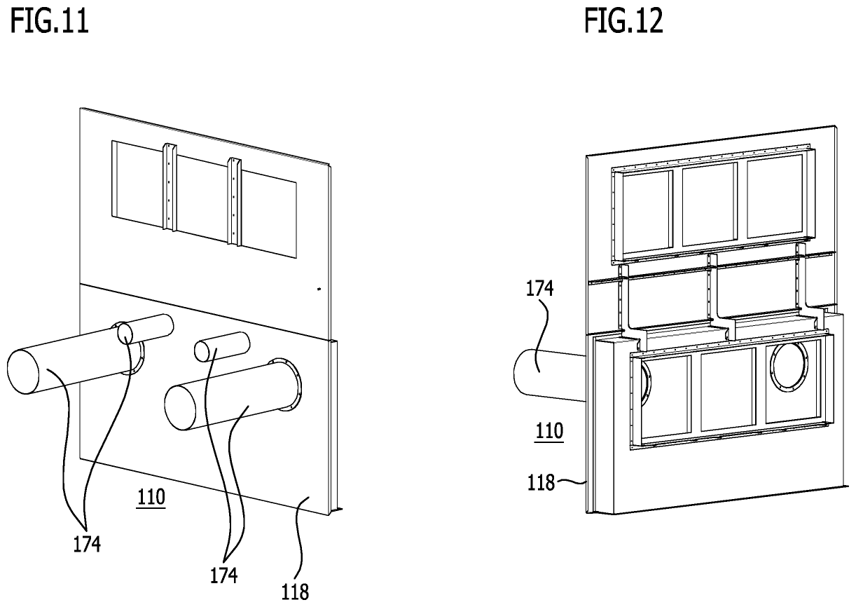

An embodiment of a side wall 118 of the housing 106 shown in FIGS. 11 and 12 may optionally be provided in each of the described embodiments of treatment systems 100.

In this case, nozzles 174 projecting into the treatment chamber 110 are provided instead of the simple supply opening 136 (see FIG. 1). These nozzles 174 projecting into the treatment chamber 110 project in particular in the horizontal direction away from the vertical side wall 118 and likewise serve to avoid contamination of the workpieces with condensate. In addition, a more direct inflow of the workpieces at preferably higher flow velocities can take place as a result, whereby a more efficient temperature control can be attained.

This takes place by the inward-projecting nozzles 174 essentially in that condensate forms primarily on the vertical side wall 118, but then can simply run downwards on the vertical side wall 118. In particular, condensate dripping into the supply openings 136 (according to FIG. 1) can be avoided by the inward-projecting nozzles 174. The condensate thus cannot be entrained by the supplied cooling gas flow and, consequently, cannot contaminate the workpieces.

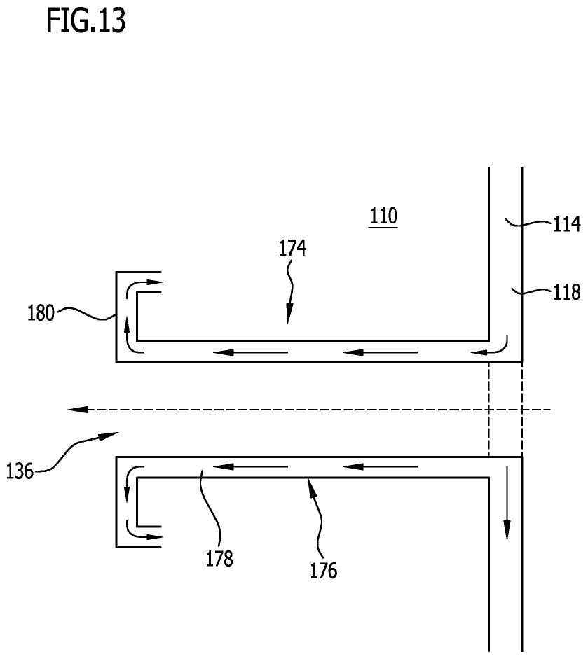

FIG. 13 schematically shows an optional development of the inward-projecting nozzles 174. In this development, it is provided that the inward-projecting nozzles 174 have a double wall 176 at least in portions or across their entire circumference and/or length. In intermediate wall region 178 formed within the double wall 176 can preferably be flowed through and be fluidically connected to the side wall 118 in such a way that heating gas conducted in the side wall 118 flows into the intermediate wall region 178 and thus can heat the inward-projecting nozzles 174.

An annular and/or collar-shaped flow deflection 180 is preferably provided at an end, facing away from the side wall 118, of the inward-projecting nozzles 174—in particular, in the region of the supply opening 136. By means of the flow deflection 180, the heating gas can be deflected, for example, by at least approximately 90°, and preferably by at least approximately 135°, e.g., by approximately 180°, and can be introduced into the treatment chamber 110.

As a result, the inward-projecting nozzles 174 can preferably be heated at least in the portions that come into contact with solvent-containing and/or cooler air, in order to avoid condensate formation.

In further embodiments (not shown) of treatment systems 100, various aspects of the treatment systems 100 described above can be combined with one another as needed in order to enable further preferred embodiments. In particular, in the embodiment shown in FIGS. 7 and 8, an additional flow of heating gas behind a ceiling wall 120 or behind a vertical side wall 118 may also be provided.

### List of Reference Signs

100 Treatment system
102 Dryer
104 Cooling module
106 Housing
108 Interior
110 Treatment chamber
112 Cooling zone
114 Treatment chamber wall
116 Base wall
118 Side wall
120 Ceiling wall
122 Housing wall
124 Partition wall
126 Metal sheet
128 Inner side
130 Cooling gas flow supply
132 Supply channel
134 Pressure chamber
136 Supply openings
138 Cooling gas chamber
140 Cooling gas flow channel
142 Cooling gas box
144 Nozzle box
146 Heating gas flow supply
148 Heating region
150 Outer side
152 Heating gas chamber
154 Intermediate wall
156 Insulating material
158 Insulation material
160 Supply channel
162 Connection slot
164 Gap
166 Weld stud
168 L-angle
170 Inspection access
172 Guide channel
174 Nozzle
176 Double wall
178 Intermediate wall region
180 Flow deflection

1. Treatment system for treating workpieces, in particular, vehicle bodies, the treatment system comprising:
a housing which surrounds a treatment chamber;
a cooling gas flow supply for supplying a cooling gas flow to the treatment chamber; and
a heating region which is adjacent to the cooling gas flow supply or forms a component thereof.

2. Treatment system according to claim 1, wherein the treatment system includes a heating device for actively heating the heating region, and wherein the heating device includes one or more burner elements and/or one or more ohmic heating elements.

3. Treatment system according to claim 1, wherein the heating region is or includes a partition wall delimiting the treatment chamber, wherein the partition wall in particular includes from one or more metal sheets or is formed therefrom.

4. Treatment system according to claim 3, wherein an outer side, facing away from the treatment chamber, of the partition wall delimits a heating gas chamber to which heating gas can be supplied from a heating gas flow supply of the treatment system.

5. Treatment system according to claim 3, wherein an outer side, facing away from the treatment chamber, of the partition wall is provided with a thermal insulation.

6. Treatment system according to claim 1, wherein the cooling gas flow supply is guided through the heating region and/or surrounded by the heating region.

7. Treatment system according to claim 1, wherein the cooling gas flow supply includes one or more cooling gas flow channels for introducing the cooling gas flow into the treatment chamber, and wherein one or more of the cooling gas flow channels traverse a heating gas chamber for heating the heating region.

8. Treatment system according to claim 7, wherein one or more of the cooling gas flow channels fluidically connects a cooling gas chamber to the treatment chamber, and wherein the heating gas chamber is arranged between the cooling gas chamber and the treatment chamber.

9. Treatment system according to claim 1, wherein a heating gas chamber for heating the heating region is fluidically connected to the treatment chamber.

10. Treatment system according to claim 9, wherein the treatment system includes one or more connection slots for fluidically connecting the heating gas chamber to the treatment chamber, wherein the one or more connection slots is in particular arranged between a portion of a treatment chamber wall, in particular, of a partition wall of the treatment system, which portion forms a heating region, and a further portion of a treatment chamber wall, behind which portion in particular no heating gas flows.

11. Treatment system according to claim 10, wherein one or more of the connection slots is arranged between: a) a portion of the treatment chamber wall, which portion forms an at least approximately vertical side wall, and b) a heating region.

12. Treatment system according to claim 10, wherein one or more of the connection slots is arranged between a) a portion of the treatment chamber wall, which portion forms an at least approximately horizontal ceiling wall, and b) a heating region.

13. Treatment system according to claim 1, wherein the heating gas flow supply forms or includes a flow guide by which lock supply air from a lock of the treatment system or from a branching of a supply channel of the lock air can be supplied as heating gas to the heating region for heating the heating region.

14. Treatment system according to claim 1, wherein a cooling gas flow supply is provided in and/or on a partition wall and/or a side wall of the housing, in particular, a vertical side wall of the housing and includes nozzles which, starting from the partition wall and/or the side wall, project into the treatment chamber.

15. Method for treating workpieces, the method comprising: introducing one or more workpieces into a treatment chamber, which is surrounded by a housing, and/or conveying one or more workpieces through the treatment chamber;
supplying a cooling gas flow by a cooling gas flow supply to the treatment chamber for cooling the one or more workpieces; and heating a heating region adjacent to the cooling gas flow supply.

16. Treatment system according to claim 1, wherein the heating region is heated to a temperature that is above a temperature of the cooling gas flow.

17. Method according to claim 15, wherein the heating region is heated to a temperature that is above a temperature of the cooling gas flow.
